(19) United States
(12) Patent Application Publication
(10) Pub. No.: US 2008/0154944 A1
(43) Pub. Date: Jun. 26, 2008

(54) Automated online ecommerce system for sponsorship acquisition and retention

(76) Inventors: Larry Joseph Erdos, Butler, PA (US); Darrell Gregory Erdos, Bulter, PA (US); Matthew Joal Erdos, Butler, PA (US); Christopher Ryan Erdos, Butler, PA (US)

Correspondence Address: Larry J. Erdos, 134 Barrickman Dr., Butler, PA, 16001, US

(21) Appl. No.: 12/004,162

(22) Filed: Dec. 20, 2007

Related U.S. Application Data
(60) Provisional application No. 60/871,216, filed on Dec. 21, 2006.

(51) Int. Cl. G06F 17/30

(52) U.S. Cl. 707/102; 707/E17.009

(57) ABSTRACT

In a computer environment, the present invention is a method for allowing a user to quickly and effectively purchase a sponsorship on an Internet website, comprising choosing a location on a virtual object having a visually concealed continuous interconnected net of a particular shape on the website, wherein the virtual object is a virtual representation of an actual physical object, entering a message in the location, choosing an event associated with the physical object, creating a master file with the location, message event information, electronically sending the master file to a service provider of the physical object and automatically creating and printing a paint scheme by the service provider on a medium configured to wrap around the physical object, wherein the paint scheme is a tone-on-tone paint scheme configured to blend with an overall paint scheme of the object.

### CROSS REFERENCE TO RELATED APPLICATIONS

This application is based on and claims priority to Provisional Patent Application Ser. No. 60/871,216 filed Dec. 21, 2006, entitled “This invention is an automated online/digital system that enables a race team to increase their sponsorships . . . ”, by Erdos et al.

### BACKGROUND OF THE INVENTION

Websites for the World Wide Web are frequently used by publishers for advertising, marketing, promotion, news, information, entertainment, etc. purposes. However, websites are not used to automate sponsorship acquisition and retention for professional and celebrity entertainment initiatives, such as NASCAR™.

### SUMMARY OF THE INVENTION

In a computer environment, the present invention is a method for allowing a user to quickly and effectively purchase a sponsorship on an Internet website, comprising choosing a location on a virtual object having a visually concealed continuous interconnected net of a particular shape on the website, wherein the virtual object is a virtual representation of an actual physical object, entering a message in the location, choosing an event associated with the physical object, creating a master file with the location, message event information, electronically sending the master file to a service provider of the physical object and automatically creating and printing a paint scheme by the service provider on a medium configured to wrap around the physical object, wherein the paint scheme can be either a tone-on-tone paint scheme configured to blend with an overall paint scheme of the object or configured in a single or full color manor to be more prevalent on the object.

### BRIEF DESCRIPTION OF THE DRAWINGS

FIG. 1 is a block diagram representing an overview of one embodiment of the present invention.

FIG. 2 is a flow chart demonstrating the general process of one embodiment of the present invention.

FIG. 3 is a block diagram representing details of the different components of one working example embodiment of the present invention.

FIG. 4 is a flow chart demonstrating one user interface process of one embodiment of the present invention.

FIG. 5 is a flow chart demonstrating one user interface process of one embodiment of the present invention.

FIG. 6 is a flow chart demonstrating a general e-commerce process of one embodiment of the present invention.

### DETAILED DESCRIPTION OF PREFERRED EMBODIMENT

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

The present invention is an automated online ecommerce system for sponsorship acquisition and retention. The online system enables a race team or other businesses to increase their sponsorships and advertising revenue by offering entities, such as individual fans and companies, the ability to purchase a sponsorship online. This can be accomplished by allowing the entities to purchase a space that includes, but is not limited to, their name, company's name or information and image or logo on an actual high profile device of the business seeking sponsorship, such as a racing vehicle at a race of their choice, in conjunction with the logos of any primary and associate sponsors.

This is achieved by covering the vehicle with an interconnected “net” of a particular geometric shape, such as but not limited to, a diamond, circle, square, star, octagon, etc., or by a random and unconnected network of spaces on the vehicle's surface. The invention can control the appearance of network of spaces as they would appear on the wrap and there control the appearance on the vehicle. The network of spaces can be made to appear as a tone-on-tone so as to blend with the primary scheme of a larger sponsor on the vehicle or can be all of a single color or full color so as to standout more on the vehicle.

In one embodiment, the automated online ecommerce system for sponsorship acquisition and retention is used for NASCAR™ race cars or any other racing vehicles, “show cars,” support equipment, “transporters,” support vehicles, objects and other transportation vehicles, etc. (the “vehicle”). After the online process is done, the online system sends data to a decal service provider to “wrap” the vehicles with a full or partial body vinyl skin or wrap that is printed with the vehicle's paint scheme and the sponsors' logos and/or information incorporated into the scheme of the wrap using the online system. The wrapping process replaces painting the vehicle with the desired paint scheme and then applying separate vinyl graphics of each sponsors' logo. The vinyl wrap can be easily and quickly changed and removing it will not harm the underlying surface.

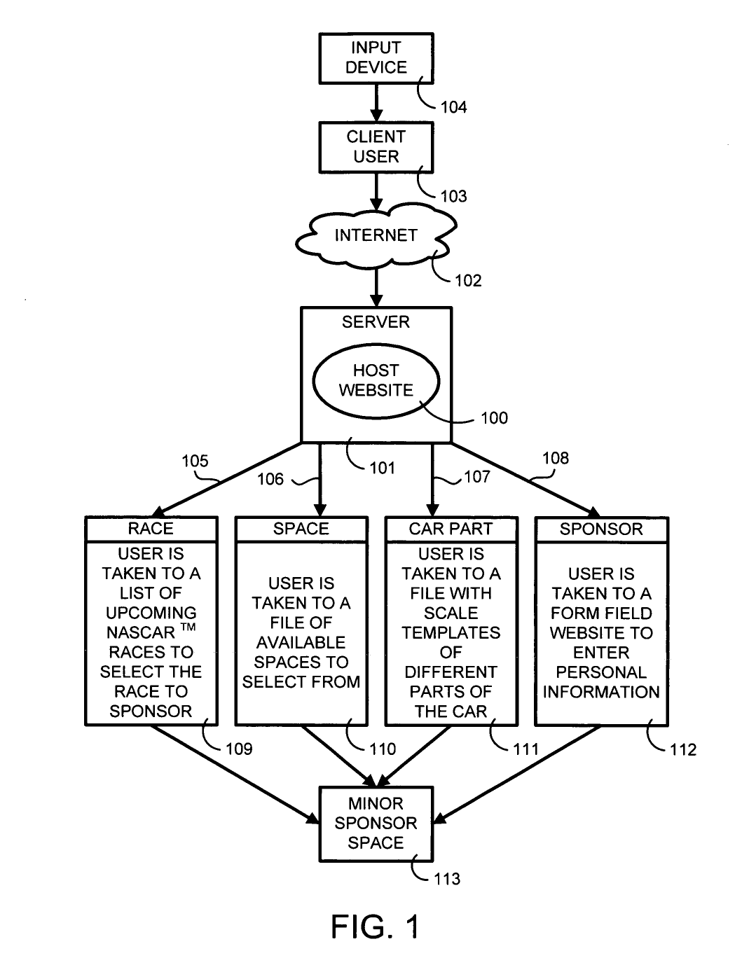

FIG. 1 is a block diagram representing an overview of one embodiment of the present invention. This embodiment will use as the example a NASCAR™ race car in a NASCAR™ Nextel/Sprint Cup Race. In this embodiment, a host website 100 is used to store information regarding upcoming NASCAR™ races, car part scale templates, file of available geometric shapes and Major and Minor Sponsors' information. The host website 100 can be hosted on a World Wide Web server 101 that is connected to the Internet 102 to allow client user machines 103 to connect to the host website 100. The client user 103 accesses the host website 100 and selects a race 105, a space 106 and a car part 107 and enters some personal information 108. This information is then combined to create a sponsor in the designated space 113.

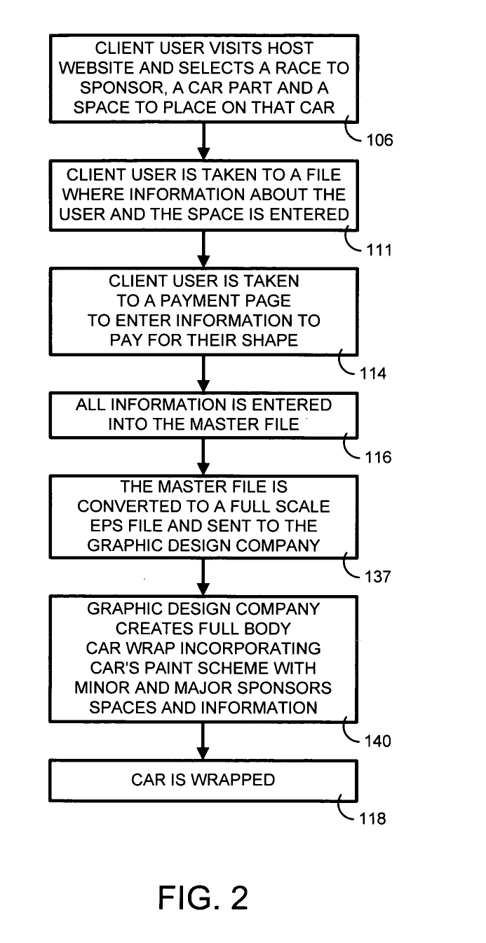

FIG. 2 is a flow chart demonstrating the general process of one embodiment of the present invention. From the host website 100 reached via the Internet 102 an individual or company (a “Minor Sponsor”) 103 can chose a race(s) they want to sponsor as shown in FIG. 1. In addition, the part of the race car on which they would like to advertise can chosen and then a geometric shape or group of shapes can be purchased 106 to be placed in their shape space.

### Detailed Components and General Working Example:

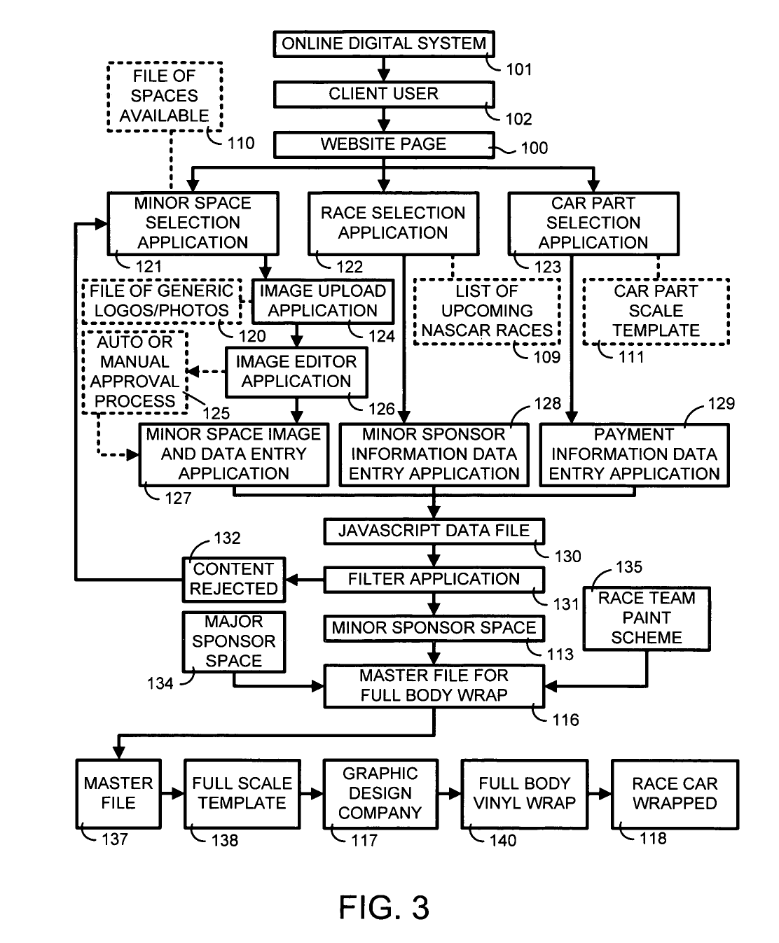

FIG. 3 is a block diagram representing the details of the different components of one working example embodiment of the present invention. For purposes of illustration and explanation, this example uses a NASCAR™ race car in a NASCAR™ Nextel/Sprint Cup Race. In general, a host website page 100 of FIG. 1 is used with a setup application 122 that contains a list of upcoming NASCAR™ races 109, a scale template of available race car parts 111 and a file of available spaces and sample logos 120.

The Minor Sponsor visits the host website page 122 reached via the Internet or other means by, but not limited to, a desktop computer, laptop or notebook computer, any mobile device, or any other internet-enabled mobile or mobile computing device. The host website page 122 contains a list of upcoming NASCAR™ Nextel Cup races 109, showing which races are still available, and the Minor Sponsor chooses the race or races they wish to sponsor. The Minor Sponsor is then taken to a website page 123 that contains scale templates of available parts 111 of the NASCAR™ race car to choose the part of the car where they want their information to appear.

The Minor Sponsor is then taken to a website page 121 that contains a file of available spaces 110 that coincide with the overall design scheme of the NASCAR™ race car. The Minor Sponsor selects his Minor Sponsor Space. This setup application can be a back-end administration system which shows the available spaces and their locations on the race car. In one embodiment, a multimedia application can be used, such as Adobe's Flash®, Shockwave, which will be a live rendering of the current, actual interconnected net of geometric shapes as they will appear on the race car.

The Minor Sponsor is taken through several steps to set up their own individual space. First, they are then taken to a form-field website page 128 to enter personal information about the Minor Sponsor (including but not limited to name, e-mail address, address, phone number, etc.). The Minor Sponsor is then taken to a form-field website page 127 to enter the information to be placed in their chosen space (including but not limited to message text to viewers to be displayed on their space, logo, banner, photos, etc.).

The Minor Sponsor can then be taken to an image upload area 124 where they can upload images desired to be placed inside their chosen space (photos, logos, drawings, etc.). This allows the Minor Sponsor to visually customize their space. Various types of image formats can be used, including but not limited to jpg, gif, png. etc. If the Minor Sponsor does not have an image to supply or does not wish to use their own image, generic images can be selected from the sample image file 120 provided. Also the Minor Sponsor can elect to not use an image at all and simply use text. Some images and/or text may cause a delay in processing and manual approval process 125 could be used to allow compliance with standards established by the vehicle owner or the sport.

Next, the Minor Sponsor is taken to an online image editor 126 that allows them to move, crop, size, etc. their image that is to be displayed in their shape. The image and data are then uploaded and written into a data file 130, such as a data file for a JavaScript. Content can be regulated through the use of a filter 131 which can be programmed to identify any content that does not fit the guidelines established by the vehicle owner and either accepted or rejected 132.

Minor Sponsors can pay for their space(s) through various means, such as cash, check, credit card, via mail, phone, fax, in person or an on-line payment service, such as but not limited to “PayPal”, “Charge,” “Checkout,” “PayNet,” “Creative Cash Flow Solutions,” or “Authorize.net.” This information is entered into the form field website page 129 by the Minor Sponsor. The process accepts the information that is to go in the space or group of spaces being purchased and payment for the sponsorship order on-line, or by other means, and adds that information to the master database file 116 for the race car body wrap.

Once all of the Minor Sponsor spaces on the car have been sold or a race deadline or other deadline has arrived, the master file 116 containing the accepted Minor Sponsorship Space orders is converted to a Master File 137 such as working EPS file or other type file required by the graphic design company 117 that shows the exact scale template of the car 138 as it will look with the full body wrap 140. The wrap 140 contains a net of all of the geometric shaped spaces and content of each Minor Sponsor's space, incorporated into the race car's paint scheme, along with the other major sponsor logos (Major Sponsor space).

The final Master file 137 is sent to the graphic designer or graphics company 117 who then utilizes this file to create the full body vehicle wrap 140. The wrap is then installed on the NASCAR™ race car 118. This process is repeated for each race so that the Minor Sponsor can change their space as they want for each race they have selected.

The order-taking data acquisition portion could be presented as a one page Web form, in a tutorial or wizard format, or in multiple webpage format. It could also be provided via a hardcopy order form and then entered into the system by data entry personnel. The data acquired during the order taking process then populates a master file 116 that is finally converted to a proper scale Master file 137 for printing. Taking of the order and data on-line, populating that data into a master file 116, and then converting the master file 116 to a proper scale, ready to print Master file 137 that can be printed onto the wrap and applied to the vehicle 118 or object can be achieved in any suitable programmatic manner.

The present invention could be used to maximize advertising, information, or graphic space on anything such as but not limited to: racing vehicle, buildings, clothing, sportswear, sportswear worn by professional athletes, “wrapped” billboards and “signage,” sports equipment, transportation vehicles like, cars, motorboats, ships, sailboats, motorcycles, trucks, buses, trains, aircraft—in short, it can be used to maximize advertising, information and/or sponsor space on anything that can be printed, fabricated, worn or covered. It is a quick and cost-effective way to get information, product, service or personal information out to a large volume of people.

### Specific Working Example

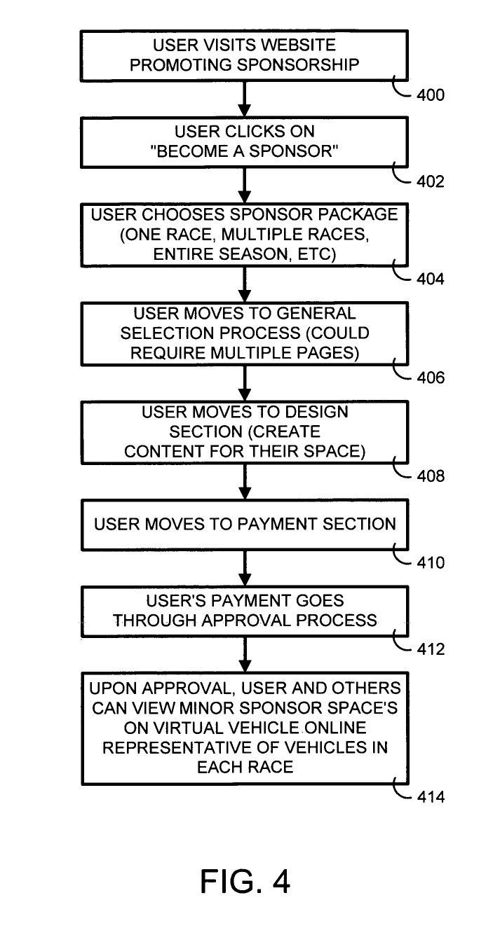

FIG. 4 is a flow chart demonstrating one user interface process of one embodiment of the present invention. The promotional website can provide the user with information regarding their sponsorship opportunities (step 400). The website can include separate components that can assist the user in making their decision. For example, Flash components can illustrate the virtual car, in conjunction with JavaScript, ASP.NET, and xHTML. The promotional website can include of Flash, JavaScript, ASP.NET, CSS, and xHTML.

A user can click on a “become a sponsor” link (step 402). This link button can redirect the user to a Secure Hyper Text Transfer Protocol (https) website that can hold all data confidential and secure. The user can choose a sponsor package (one race, multiple races, entire season, etc) (step 404). The sponsorship packages can be displayed with user friendly selection options, such as a dropdown or radio button selections. Several options of race packages can be available to the user. The user's selection and the steps that follow can be stored in a session, cookie, viewstate or database until finalized.

The user can choose a specific race(s) if applicable and/or available (step 406). Specific race selection can be made available and the user can select by venue, date and or name. A radio button can be used to list the items for easy selection (either HTML or ASP.NET components can be used for example). Races can be stored in a session, cookie, viewstate or database until finalized. The user selection process could be programmed as a Flash, .NET/JavaScript page.

The virtual car can be setup as a 3D rotating object or a flat static object. The user can have multiple steps for choosing the location. The user can choose the general location for their sponsorship. (hood, right, left, TV panel, etc. of the car) The user can then choose the specific space or shape, such as a diamond, for the location. At anytime, the user can “click” to continue to allow the sponsor a random location based on the criteria already chosen.

A content and color option can be used to allow the user to choose what color and how their text, descriptions and/or images or logo are presented on the car (step 408). If space sizes are available, the user can be presented with a scaled size image through a description; where they can choose which size desired. Size may have limitations based on sponsorship price. In step 408, the user can be prompted with a screen that will allow the user to input characters based on the size chosen above. These limitations will be enforced and will be filtered based on language, character limits and format. Language filters will be in place that will restrict the user from entering harmfully or offensive language.

The user can be provided with an interface where they can position their message based on the space or shape chosen above. After the user finalizes the location and size of the message or image, the message or image is processed to their specifications. A separate program on the local machine can be used to manipulate the message or image, cut the message or image and mask the message or image to the appropriate size and state. The message or image can then be saved into the temporary file until the process is completed.

The user is next prompted with payments options and a form for credit card/account information (step 410). This form will be secure and all information will be hosted behind a firewall. Payments by credit card can be processed though and API provided by the merchant. If the user is declined, they will be able to save changes and come back with a valid credit card or a different credit card. Changes will be saved under an IP, sequentially generated username, and password. After returning to the order, the user will be prompted for a password if they have already started the application process to continue where they left off.

There can be a delay in processing time to ensure the payment is received. Once the payment is received, user access will be given to their account. Payment can be transferred to the Merchant's API and checked for approval. Upon approval, all of the stored information will be processed and stored in a secure database which can be one-way encrypted passwords and secure information so that the user can only be able to get the information (step 412).

After the sponsorship is approved and the required information is presented, the user can then be given access to administration panel (step 414). The User can be notified by either email and/or phone depending on the user's credentials. The user's data is then transferred into an active database where all the information will be stored for the racing website, EPS wrap and virtual car. All images will be stored in a file system for quick access from both the flash virtual car and EPS writing. The user and others can view Minor Sponsor space(s) on virtual vehicle online representative of vehicles in each race.

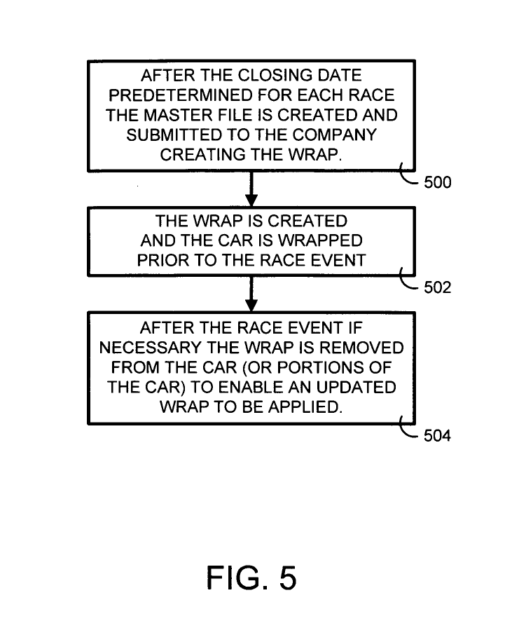

FIG. 5 is a flow chart demonstrating one user interface process of one embodiment of the present invention. After the closing date predetermined for each race, the Master File is created and submitted to the company creating the wrap for the car (step 500). A programmed or manual trigger will be placed on the wrap creation process to create the Master File for each race. The process is started by a program that connects to the database to find all the sponsors for this specific race. The program determines the details about each sponsor (logo, text, color, quantity, category and location). Once the information is gathered for each sponsor the program starts the wrap creating process.

A template file is then opened by the program in an EPS editing program on the local machine. This file was created for the specific sponsor application (NASCAR, Vehicle, Boat, Jersey, etc.). The file contains a pre-determined net of objects, each with an associated identification based on a location, which the program can interact with using the retrieved sponsor's order details. The program goes through each sponsor's information and as it reads each, it adds the logo, text, and color to the requested space by the sponsor in the EPS file. Once the program determines the EPS file is complete it saves the file and uploads to the server for the wrap to be printed. The wrap is created and the car is wrapped prior to the race event (step 502). After the race event if necessary the wrap is removed from the car (or portions of the car) to enable an updated wrap to be applied (step 504).

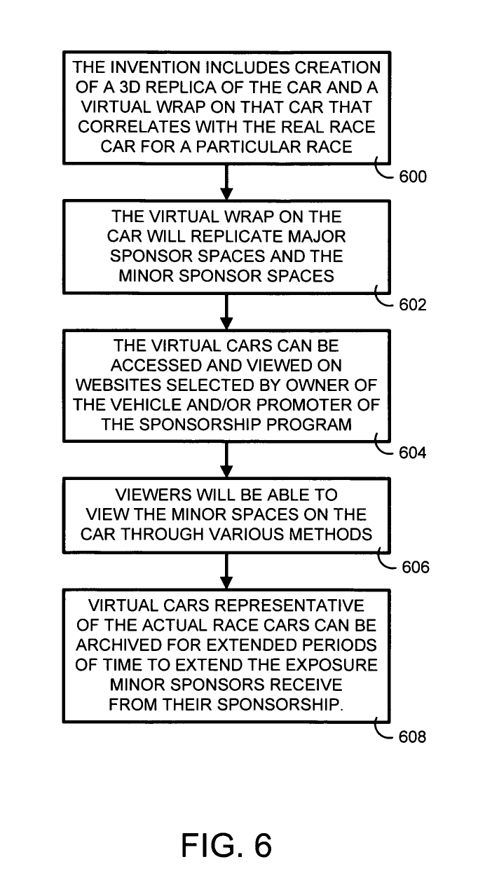

FIG. 6 is a flow chart demonstrating one user interface process of one embodiment of the present invention. The invention includes creation of a 3D replica of the car and a virtual wrap on that car that correlates with the real race car for a particular race (step 600). The user can rotate the car and zoom in on sections of the car. The user can have two methods to rotate the car in 3D form. The user's ability to rotate the car can be based on one directional rotation (locking axis not in use). The user can rotate the car on one axis at a time or have the ability to rotate the car in free rotation and give the user full control over rotation. Both rotation methods will be achieved in Flash and will load the wrap externally for better load times. Upon the user “zooming” into the virtual car, the logos and text will become visible and clearer. The specific car will have limited zoom capabilities for easier user navigation and control.

The virtual wrap on the car can replicate Major Sponsor spaces and the Minor Sponsor Spaces (step 602). All of the data can be acquired though the database and brought in via XML. The Flash file can then manipulate the data to the proper location loading all the images externally so that the user does not have to wait for all the sponsors' logos to load. This will also allow for one scheme that can continually be altered by the external files and not have to be manually redone by the Flash file.

The virtual cars can be accessed and viewed on websites selected by user controlling the vehicle and/or promoter of the sponsorship program (step 604). All of the data can be archived in the database and the file system for later use so that the user can view the virtual information throughout the whole race season and future seasons to come. Viewers can also allow viewing of the Minor Spaces on the car through various methods (step 606). One is random searching. Another search method can be specific searching. For example, viewers can enter a company name in a search bar the will reveal that Minor Space's location on the virtual car. After searching, a query to the database can be made and return all of the criteria specified information in XML. Clicking on that space can reveal the complete Minor Sponsor Space content. Clicking on the content can also connect the viewer to the Minor Sponsor's website.

Another search method is category searching. Viewers can search from a list of Minor Sponsors listed under categories. After searching, a query to the database can be made and all of the criteria specified in XML can be returned. Clicking on a company listed can reveal the location of their Minor Sponsor space on the virtual car. Clicking on that space can also reveal the complete Minor Sponsor Space content on the virtual car. Clicking on the content will connect the viewer to the Minor Sponsor's website.

In addition, hovering the cursor arrow over the various parts of the car can cause spaces to become visible when and where the cursor stops. When the user uses the cursor or keyboard to navigate the page, when the user stops, it can query the database and get all the information for that sponsor in XML. The information can then be presented to the user.

Last, virtual cars representative of the actual race cars can be archived for extended periods of time to extend the exposure Minor Sponsors receive from their sponsorship (Step 608).

In summary, the present invention enables a user to quickly and easily increase their sponsorship and advertising revenue by allowing the user to include their message in an overall design of a vinyl wrap for a race car or other racing vehicle or vehicle, building, or other structure. The user browses a website and selects from a number of options including but not limited to: size, shape, price, color, etc. and then provides an associated logo, text and other messaging.

The user can then pick an event (e.g. a particular race) and the part of the vehicle on which they wish to advertise. The user's choices are incorporated into a custom design for their space which is then included along with other Minor Spaces into an overall car scheme that also includes Major Sponsor Spaces that can include primary sponsors who's logo often dominate the car design and color scheme. This invention enables the Minor Sponsor spaces to be presented in a tone-on-tone way so as to blend in with the Major Sponsor Spaces, the car design and the car color scheme or it can enable the Minor Sponsor Spaces to show on select areas of the car or on the entire car in single color or full color making each space distinct in and of itself so as to standout on the car. The mode is chosen prior to the completion of the Master File that is provided to the graphic design company for production of the vinyl wrap which is placed on the vehicle.

An embodiment of the present invention enables companies, individuals and others who normally cannot afford to participate in NASCAR™ race car sponsorship or elsewhere to do so. This could include having their name, message, graphic, company name and/or logo and/or image on the actual vehicle or elsewhere. In addition, the present invention enables race teams and others to increase their sponsorships and advertising revenue by offering an on-car sponsorship program that companies and individuals can afford and that maximizes the visible space on each vehicle or elsewhere. Further, the present invention automates this on-car sponsorship order taking process on-line and allows automatic updating of a master file of all of the user's information as orders are placed. The master file can be converted to a full scale Master file by a graphics company to produce a paint scheme wrap on the body of the car/vehicle with all of the logos of the major sponsors, as well as the logos of the minor sponsors into one Master file.

The foregoing has described the principles, embodiments and modes of operation of the present invention. However, the embodiments of the present invention should not be construed as being limited to the particular embodiments discussed. The above-described embodiments should be regarded as illustrative rather than restrictive, and it should be appreciated that variations may be made in those embodiments by workers skilled in the art without departing from the scope of the embodiments of the present invention as defined by the following claims.

1. In a computer environment, a method for allowing a user to quickly and effectively purchase a sponsorship on an Internet website, comprising:
choosing a location on a virtual object having a visually concealed continuous interconnected net of a particular shape on the website, wherein the virtual object is a virtual representation of an actual physical object;
entering a message in the location;
choosing an event associated with the physical object;
creating a master file with the location, message event information;
electronically sending the master file to a service provider of the physical object; and
automatically creating and printing a paint scheme by the service provider on a medium configured to wrap around the physical object, wherein the paint scheme is a tone-on-tone paint scheme configured to blend with an overall paint scheme of the object.
